(19) United States
(12) Patent Application Publication
(10) Pub. No.: US 2018/0183019 A1
(43) Pub. Date: Jun. 28, 2018

(54) Battery Cell Housing, Support and Method for Grouping a Plurality of Battery Cell Housings

(71) Applicant: Schuler Pressen GmbH, Göppingen (DE)

(72) Inventor: Bernd ULLMANN, Pfinztal (DE)

(21) Appl. No.: 15/738,884

(22) PCT Filed: Jun. 14, 2016
(86) PCT No.: PCT/EP2016/063642

§ 371 Date: Dec. 21, 2017

(30) Foreign Application Priority Data
Jun. 25, 2015 (DE) 10 2015 110 243.9

(51) Int. Cl. H01M 2/10; H01M 2/02; H01M 2/04; H01M 10/04

(52) U.S. Cl. CPC H01M 2/1016; H01M 2/02; H01G 2/106; H01M 10/0422; H01M 2/046

(57) ABSTRACT

A battery cell housing (10) includes a housing shell (12) and a housing cover (11). A holding device (20) is arranged on a bottom (15) of the housing shell (12) and is assigned a mating holding device (21) on a support (22). The holding device (20) and the mating holding device (21) are configured to be plugged positively one inside the other by a relative movement in an axial direction parallel to the housing axis (G) of the cylindrical battery cell housing (10). In this way, it is possible at the same time for a plurality of battery cell housings (10) bearing against one another to be arranged quickly and captively on a support (22) with a plurality of mating holding devices (21).

The invention relates to a battery cell housing for the accommodation of a core material providing electrical energy. The invention also relates to a support that is able to hold a plurality of such battery cell housings, or at least parts thereof, for grouping battery cell housings and parts, respectively. Finally, the invention also relates to a method for grouping the battery cell housing or its parts, in particular housing shells.

As a rule, in order to provide a battery, for example for a vehicle, a cordless, electrical device or the like, several individual battery cells are connected to each other in series and or in parallel. Handling of the battery cells when constructing the battery is very laborious. The greater the capacitance or the provided voltage of the battery, the more individual battery cells are required for the construction of the battery.

From publication DE 10 2011 015 621 A1 it has been known to hold the individual battery cells by a holding body in order to secure the battery cells used in a vehicle against unwanted movements due to shocks and vibrations. As a result of this, any breakage of soldering points or the like is to be prevented. For each battery cell, the holding element has a lateral recess that is open toward the top and the bottom and partially reaches around the peripheral walls of the battery cells in peripheral direction. Each recess of the holding element contains a strip that comes into engagement with a peripheral groove on the battery cell housing. As a result of this, the battery cell housing is secured against axial movements relative to the holding element. Clipping the battery cells into the respectively associate recess takes place in a direction transverse to axial direction.

Considering this, it may be viewed as the object of the present invention to improve the handling of the battery cells and the battery cell housings, respectively, or at least their housing shell.

According to the invention a battery cell housing for the accommodation of a core material providing electrical energy is suggested. The battery cell housing comprises a hollow cylindrical housing shell that, preferably, has a cross-sectional contour in the form of a circular cylinder. The housing shell has a bottom that is preferably circular. Extending from the bottom is a peripheral wall in a direction coaxial to a housing axis in a height direction. On the side opposite the bottom, the peripheral wall delimits a housing opening. With the battery cell housing closed, a housing cover covers the housing opening and is connected to the peripheral wall, in particular in material-bonded manner, for example by welding. The battery cell housing, i.e., the housing shell and the housing cover, are preferably made of a metal or a metal alloy, for example steel. The housing shell is produced from a blank by means of a forming process, for example by extrusion.

A holding device is provided on the bottom. The holding device is disposed to be fastened to a mating holding device of a support in a positive-locking manner. With the positive-locking connection established, the housing shell is secured on the support against unwanted axial movement.

Preferably, the holding device is disposed to establish the positive-locking connection with the mating holding device due to an axial movement in axial direction parallel to the housing axis and, if necessary, to again release this connection. The holding device and the associate mating holding device can thus form a snap-on connection due to an axial relative movement. The connection can be severed again by a sufficiently great pulling force in axial direction.

The battery cell housing can be used for any type of electrical energy storage such as, for example, a disposable battery, a rechargeable battery, a capacitor, etc.

Due to the arrangement of the holding device on the bottom and thusly related option of establishing a positive-locking connection due to an axial movement, it is possible to connect a plurality of housing shells and battery cell housings, respectively, at the same time to an associate mating holding device on a support in a positive-locking manner.

Consequently, the handling during the production of a battery comprising a plurality of individual battery cells is simplified. A defined intermediate space may be created between the battery cells, said intermediate space optionally potentially being filled with at least one filling material. For example, the filling material may be material that is a good heat conductor such as, for example a mixture of resin and particles that conduct heat well or a powder that conducts heat well, which may contain, for example, boron nitride and/or copper and/or other metals and/or carbon. Instead of the particles or the powder, it is also possible to use, for example, bodies of the mentioned materials. Heat sinks may also be arranged between the battery cells, for example those consisting of a phase-changing material (PCM material) such as, for example, sodium acetate or the like.

It is advantageous if the holding device is arranged, radially with respect to axial direction, inside a region that is delimited by a tube-shaped shell surface plane in which the peripheral shell surface of the peripheral wall is located. The shell surface plane represents—as it were—that plane that results when the peripheral shell surface is lengthened in axial direction. The holding device does not extend through this shell surface plane but is arranged inside the region delimited thereby. This ensures that several battery cell housings can be arranged tightly packed next to each other, without the holding device impairing or preventing the tightest possible arrangement of the battery cell housings.

Preferably, the holding device features an undercut. On this undercut, the radial dimension of the holding device displays a local or global minimum, radially with respect to the axial direction. For example, the undercut may be formed by tapering a holding projection or a holding recess.

Furthermore, it is advantageous if the holding device is connected in an electrically conductive manner to the interior space of the housing shell. This makes it possible to electrically connect one terminal of the core material located in the battery cell housing to the holding device, so that the holding device may form one pole of the battery cell.

It is preferred if at least one outside surface of the peripheral wall is electrically insulated relative to the interior space of the housing shell. For example, the outside surface of the peripheral wall may be an electrically insulating varnish layer. It is also possible for a sheet metal blank from which the housing shell is produced, to already have an electrically insulating coating for a forming process, said coating remaining maintained after the forming process. The coating may be removed at points where an electrical insulation is not required.

In an exemplary embodiment of the housing shell or the battery cell housing, it is also possible to electrically insulate the entire housing shell or the entire battery cell housing relative to the interior space. Only the two electrical terminals of the battery cell are then passed by means of a respective electrical conductor into the battery cell housing and electrically connected to the core material.

The holding device may have a holding projection extending away from the underside of the bottom. The holding projection preferably extends along the housing axis and thus centrally away from the bottom. Preferably, the holding projection is rotation-symmetrical with respect to the housing axis.

Furthermore, it is preferred if the dimension of the holding projection radially with respect to the axial direction is at a maximum at a point that is located at a distance from the bottom or the underside of the bottom. Between this point of maximum radial dimension and the underside of the bottom, an undercut is formed in this manner, by means of which undercut a positive-locking connection similar to that of a snap fastener can be established.

It may also be advantageous for the holding device to have a holding recess. Basically, it is possible for the holding device to have a holding projection, as well as a holding recess, in which case, preferably, one holding projection or only one holding recess is provided.

It is advantageous if the dimension of the holding recess radially with respect to axial direction is minimal at a point that is located at a distance from the bottom or the underside of the bottom. Between this point of minimal radial dimension and the underside of the bottom, an undercut of the holding recess is formed, by means of which undercut a positive-locking connection similar to that of a snap fastener can be established.

Furthermore, the invention relates to a support that is disposed for holding a plurality of the battery cell housings having the form of a cylinder as described hereinabove. The support comprises a support plate on which are arranged a plurality of mating holding devices. The mating holding devices are disposed to be fastened, in a positive-locking matter, to respectively one holding device on the battery cell housing. Furthermore, said mating holding devices are disposed to secure the battery cell housing on the support plate against an unwanted axial movement in an axial direction parallel to the housing axes of the battery cell housing.

Furthermore, the mating holding devices are disposed to establish a positive-locking connection with a respectively associate battery cell housing or with a respectively associate holding device of a housing shell, due to a relative movement in axial direction. As a result of this it is accomplished that, at the same time, a plurality of housing shells and battery cell housings, respectively, can be moved axially with respect to the support plate—e.g., with the aid of a suitable handling device—and, as a result of this, the positive-locking connection can be established. The housing shells or battery cell housings are thus engaged and held on the support, as it were. The result is an assembly that can be handled combined for the further construction of the battery.

It is preferred if the support plate has respectively one support lateral wall in one or more locations. The support lateral walls can be used for positioning the housing shells or battery cell housings before they are secured in a positive-locking manner on the support plate due to an axial relative movement.

In a preferred embodiment of the support, the mating holding devices are an integral component of the support plate. They can be shaped due to a forming process in an originally plate-shaped material.

Alternatively, it is also possible to provide the mating holding device on one or more separate fastening components. Due to the positive-locking connection of a mating holding device to an associate holding device, a fastening of the holding device and the mating holding device to the support plate is accomplished at the same time. To do so, for example, the holding device and the mating holding device may extend at least partially through a cutout in the support plate from opposite sides.

Furthermore, it is preferred if the mating holding devices provided on the support plate are arranged at a distance from each other. In doing so, the distance is selected in such a manner that the peripheral walls of adjacent battery cell housings or housing shells contact one another. Preferably, the mating holding devices are positioned in such a manner that each housing shell or each battery cell housing is in planar or linear contact with the least two additional housing shells or battery cell housings if the housing shells or battery cell housings are arranged on the support. The distance between the midpoints of adjacent mating holding devices thus corresponds to the outside diameter of a peripheral wall—provided all battery cell housings have the same dimensions.

Preferably, the mating holding devices are arranged in a regular pattern. For example, they may be arranged in the form of a matrix in rows and columns. Each midpoint of a mating holding device may form the corner point of one or more grid meshes. Each grid mesh may have a polygonal, for example square or triangular form. Preferably, each grid mesh has the form of an equilateral triangle.

Furthermore, it is of advantage if the mating holding device consists at least partially of electrically conductive material. As a result of this, it is possible to electrically contact the battery cell, or the core material arranged therein, via the mating holding device. To do so, for example a part of the existing mating holding device may be electrically connected to at least one strip conductor or at least one electrical conductor. The strip conductor or electrical conductor may be arranged on the support plate.

Thus, the support plate may be constructed in the manner of a conductor board.

For grouping a plurality of battery cell housings or housing shells, the procedure according to the inventions is as follows:

First, several battery cell housings or housing shells thereof are produced or provided as described hereinabove.

Furthermore, a support is produced or provided as explained hereinabove. The plurality of battery cells or housing shells are arranged on the support due to a relative movement in axial direction relative to the support, in which case a positive-locking connection is established between the holding devices and the associate mating holding devices. Preferably, all battery cell housings and housing shells, respectively, are moved as a group relative to the support in order to form the connection.

As a result of the method, it is possible to arrange already ready-for-use battery cells with closed battery cell housings on the support. The battery cells may already be electrically charged (formed). It is also possible to form the battery cells arranged on the support together.

Considering one method, it is also possible to arrange the still open housing shells on the support. The core materials are placed in the housing shells only subsequently, and the individual battery cell housings are closed. Finally, the battery cells arranged on the support can be formed together.

In addition to the positive-locking connection, a material-bonded connection may also be provided during a subsequent method step. The positive-locking connection is mainly intended to allow handling of the individual battery cell housings or housing shells together. For secured operation, it is possible to take additional fastening measures such as, for example, a material-bonded connection. For example, the holding devices and mating holding devices may be glued or welded together. It is also possible to use the support with its support lateral walls as a casting mold and inject flowable casting material and to at least partially pour it around the battery cell housing and thus create a material-bonded connection with the support.

It is also possible to mechanically and/or electrically connect a plurality of supports with a plurality of battery cells to each other in order to produce a battery.

Advantageous embodiments of the invention can be inferred from the dependent patent claims, the description and the drawings. Hereinafter, preferred embodiments of the invention are explained in detail with reference to the appended drawings. They show in

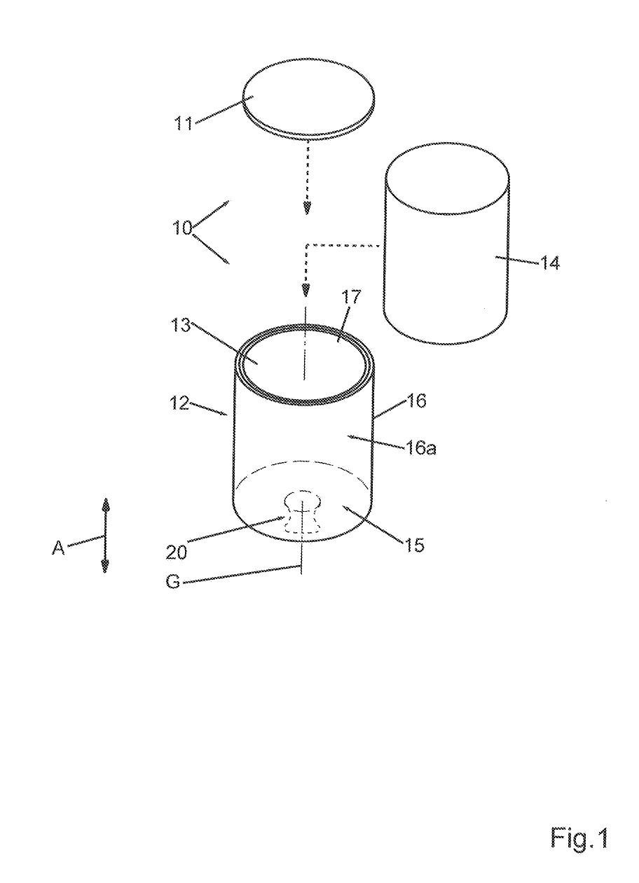

FIG. 1 a schematic perspective representation of an exemplary embodiment of a battery cell housing for the accommodation of core material;

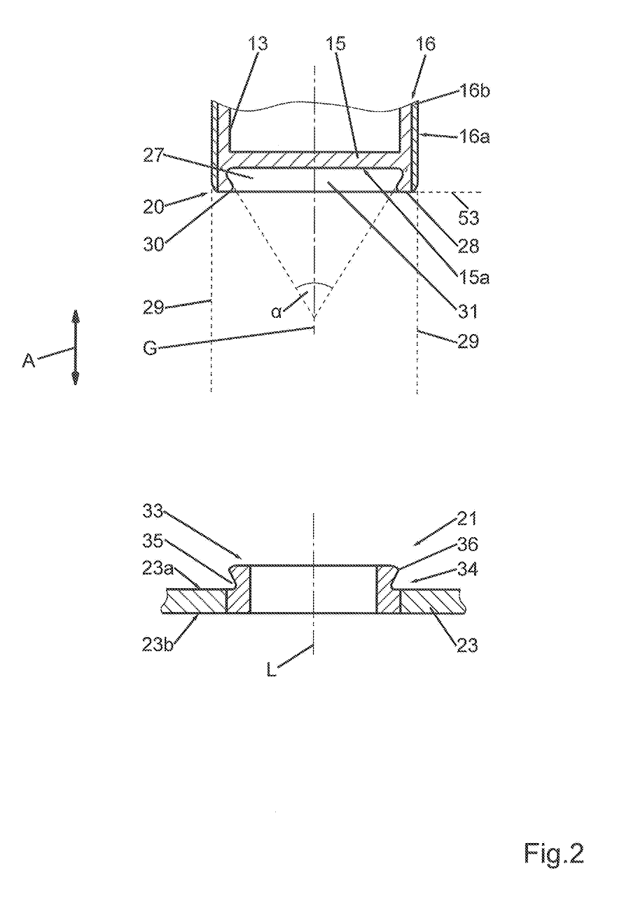

FIGS. 2-5 partial views, each in section, of an exemplary embodiment of a battery cell housing with a holding device, as well as with an associate mating holding device provided on the support;

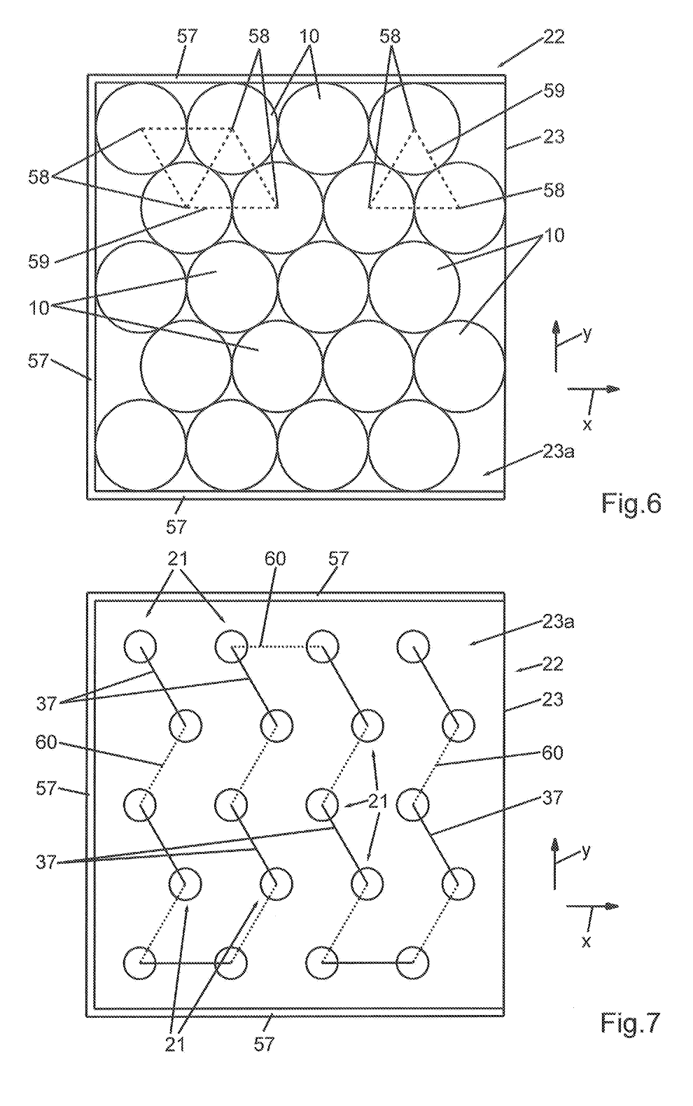

FIG. 6 a schematic representation of a support, in a plan view on a support plate, and battery cell housings arranged thereon;

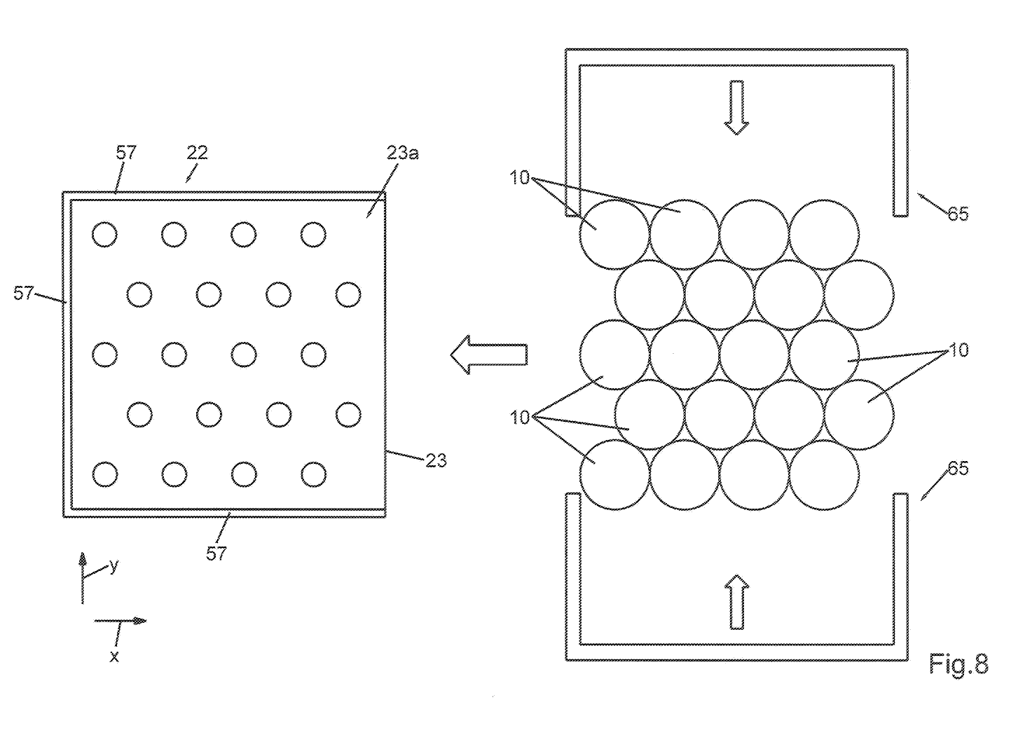

FIG. 7 a schematic representation of the support of FIG. 6, in a plan view onto the support plate; and

FIG. 8 a schematic illustration of the arrangement of the plurality of battery cell housings on the support according for FIGS. 6 and 7.

FIG. 1 shows an exemplary embodiment of a cylindrical battery cell housing 10 having the shape of a circular cylinder, said housing comprising a housing shell 11 and a housing cover 12. The battery cell housing 10 delimits an interior space 13 that is disposed for the accommodation of core material and, in accordance with the example, a solid core material 14. The core material 14 provides electrical energy that can be discharged during use with a battery cell made of the battery cell housing 10 with the core material 14. The housing shell 12 has a bottom 15 that is indicated in dashed lines in FIG. 1. Extending in axial direction A away from the bottom 15, there is a peripheral wall 16 of the housing shell. The peripheral wall 16 is arranged coaxially with respect to a housing axis G. The axial direction A is parallel to the housing axis G.

On the axial side opposite the bottom 15, there is an edge of the peripheral wall 16 that delimits a housing opening 17. The housing opening 17 can be closed by the housing cover 11 when the core material 14 is arranged in the interior space 13. Preferably, the housing cover 11 is connected to the peripheral wall 16 by material-bonding, for example by welding. The connectors of the two poles of the battery cells are passed to the outside through the battery cell housing 10 in a suitable manner, this not being specifically shown in FIG. 1.

Located on the bottom 15 of the battery cell housing 10, there is a holding device 20 that is disposed to be fastened with a mating holding device 21 to a support 22 and, according to the example, to a support plate 23 of the support 22. FIGS. 2-5 show various exemplary embodiments of the holding device 20 and the mating holding device 21 in a schematic manner, wherein always a part of the support plate 23 is shown. FIGS. 6-8 show schematic representations of the support 22.

The holding device 20 and the mating holding device 21 are designed so as to be complementary relative to each other, as it were, and are disposed for establishing a positive-locked connection due to a relative movement in axial direction A or to allow said positive-locked connection to be released again. Regarding the present explanation, it is mainly the provision of the positive-locking connection. When grouping a plurality of battery cell housings or housing cells 12 on the support 22, it is of importance that the relative movement in axial direction A leads to the positive-locked holding of the housing shells 12 on the support 22.

FIG. 2 shows a first exemplary embodiment of the holding device 20 with a holding recess 27. The holding recess 27 is delimited by a strip 28 extending coaxially about the housing axis G. The strip 28 may be closed in the form of a ring in peripheral direction about the housing axis G or have interruptions at one or more points in order to improve its radial, elastic springiness. Instead of the strip 28, it is also possible to provide two projections that are diametrically opposed or more than two projections that are arranged in peripheral direction about the housing axis G, said projections delimiting the holding recess 27. Such projections may have the same cross-sectional configuration as will be explained hereinafter in conjunction with the strip 28 of FIG. 2.

The peripheral wall 16 has an outer peripheral shell surface 16a facing away from the interior space 13. This peripheral shell surface 16a is arranged in a shell surface plane 29. Thus, the shell surface plane 29 is the axial extension of the peripheral shell surface 16a in axial direction A. The entire holding device 20 does not project from the region around the housing axis G that is radially delimited by the shell surface plane 29 relative to the housing axis G. Thus the shell surface plane 29 represents the structural clearance of the battery cell housing 10 that is not expanded by the holding device 20. Consequently, a plurality of battery cell housings 10 can be arranged densely packed next to each other so that their peripheral shell surfaces 16a are in contact with each other.

In accordance with the example, the strip 28 represents the axial extension of the peripheral wall 16 beyond the bottom 15. In accordance with the example, the outside circumference of the strip extends in the shell surface plane 29 or, alternatively, it could be arranged radially thereto farther inside and thus closer to the housing axis G.

On the side facing the housing axis G, the strip 28 has a radial projection 30 that, in this case, is configured as an annular bead. Due to the radial projection 30, the dimension of the holding recess 27 is the smallest measured, radially with respect to the housing axis G. The holding recess 27 has an undercut 31 in the region of the radial projection 30. Starting from this undercut 31, along the housing axis G toward an underside 15a of the bottom 15, the radial dimension of the recess 27 increases—at least in an axial region that adjoins the radial projection 30. Surface sections extending obliquely with respect to the housing axis G extending in this axial region on the strip 28 can be configured as flat surfaces or curved surfaces. In the region in which the holding recess 27 radially widens starting from the undercut 31, it is possible to apply tangents that intersect at an angle α, wherein the point of intersection is located at a distance from the underside 15a of the bottom below the housing shell 12. In accordance with the example, the point of intersection is located on housing axis G.

The mating holding device 21 associated with the holding device 20 is—at least in some sections—configured to be complementary to the form of the holding recess 27, so that a positive-locking connection can be accomplished. To do so, the holding device 21 according to the exemplary embodiment of FIG. 2 comprises a mating holding projection 33 with an end section 34 that extends away from a plate upper side 23a of the support 23 in axial direction A. The outside contour of this end section 34 is adapted to the inside contour of the recess 27. Accordingly, the end section 34 has an annular peripheral recess that adjoins the plate upper side 23a. Axially adjacent to the peripheral recess 35, there is a peripheral projection 36 that extends away radially with respect to a longitudinal axis L of the mating holding device 21. The maximum radial outside dimension in the end section 34 is the smallest at one point of the of the peripheral recess 35 and the greatest at one point of the peripheral projection 36—each measured radially with respect to the longitudinal axis L. With the positive-locking connection established, the radial projection 30 comes into engagement on strip 28 with the peripheral recess 35 of the mating holding device 21, so that a relative motion lock is created in axial direction A due to the positive-locked connection. While the connection is being established, the strip 28 snaps elastically open in radial direction, and/or the end section 34 snaps inward in radial direction relative to longitudinal axis L. As has been mentioned hereinabove, the mating holding projection 33, or at least the end section 34, may—alternatively to the schematic representation of FIG. 2—not be configured as a region that is closed in a ring-shaped manner in peripheral direction about longitudinal axis L but may be configured by several individual projection elements arranged in peripheral direction about longitudinal axis L in order to improve the elastic resilience for establishing the positive-locked connection.

FIG. 2 shows schematically that the mating holding projection 33 may by a cylindrical and, in accordance with the example, be a hollow cylindrical component. The mating holding projection 33 may be arranged on or fastened to the support plate 23. As an alternative to the illustration, it is also possible for the mating holding projection 33 to be an integral component of the support 22 or the support plate 23 and be configured without seams and joints in one piece. For example, the mating holding projection 33 can be produced in the support plate 23 by a forming process.

Considering the exemplary embodiment depicted by FIG. 2, the peripheral wall 16 has an electrically insulating layer 16b. This layer 16b may be a varnish or a coating. The coating may have already been applied to a sheet metal part or starting material before the housing shell 12 has been produced by forming. The layer 16b may also be applied only after forming the housing shell 12.

Alternatively or additionally, an electrically insulating layer 16b may be provided on the side of the peripheral wall 16 facing the interior space 13 and/or the bottom 15 and/or the housing cover 11. Consequently, it is possible to electrically insulate the entire interior space 13 relative to the battery cell housing 10, in which case only the line openings for electrically contacting the core material 14 need be passed through the insulation.

At the same time, the holding device 20 can be used for outer electrical contacting with the core material 14 that is arranged in the battery cell housing 10. To do so, an electrically conductive connection can be established between the core material 14 and the holding device 20 in that, at least at one point, no insulation is provided between the bottom 15 and the core material 14 but that, rather, the bottom 15 is electrically connected to one terminal of the core material 14. If the housing shell 12 consists of electrically conductive material, this results in an electrical connection to be created between the holding device 20 and, in accordance with the example, the strip 28 and the core material 14.

In conjunction with this, it is also possible to make the end section 34 or the entire mating holding projection 33 of electrically conductive material, so that, with the positive-locking connection with the associate holding device 20 being established, it is also possible to achieve an electrical connection between the mating holding projection 33 and the respective terminal of the core material 14. In the case of this exemplary embodiment, it is expedient to insulate the mating holding device 21 relative to the support plate 23 and, for example, arrange it as a separate conductive component on an inherently insulating support plate 23, as is illustrated by FIG. 2, for example. Then, it is possible to provide optional conductor strips 37 for the electrical connection of several mating holding devices 21 (FIG. 7). As a result of this, the support plate 23 may be configured in the manner of a conductor board. Here, express reference is made to the fact that the illustration of FIG. 7 is highly schematized and that the mating holding devices 21 are illustrated symbolically by circles and the conductor strips 37 are represented by solid lines.

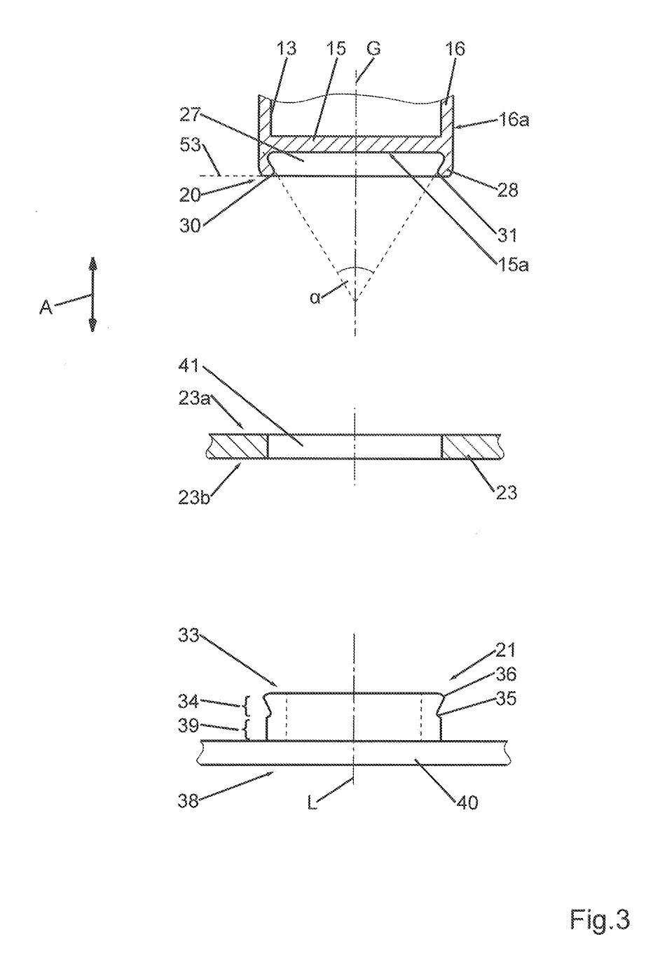

FIG. 3 illustrates an exemplary embodiment, wherein the mating holding device 21 and the support 22 or support plate 23 are modified compared with the embodiment according to FIG. 2. The battery cell housing 10 and the holding device 20 correspond to the example according to FIG. 2, so that reference may be made to the description hereinabove. The optionally provided electrically insulating layer 16b is not shown in FIG. 3; however, it may be present.

The essential difference between the exemplary embodiment according to FIG. 3 and that of FIG. 2 consists in that the mating holding projection 33 of the mating holding device 21 is arranged on a separate fastening part 38. The end section 34 having the peripheral projection 36 and the peripheral recess 35 is connected to a mating holding part 40 via a connecting section 39, said mating holding part being configured as a plate according to the example. The support plate 23 has a cutout and, in accordance with the example, a circular cutout 41. In order to establish the positive-locking connection the fastening part 38 is inserted—with the end section 35 and the connecting section 39—through the cutout 41 until the mating holding part 40 abuts against a plate underside 23b of the support plate 23. In this position, the connecting section 39 is located inside the cutout 41. As in the exemplary embodiment according to FIG. 2, the end section 35 extends away from the plate upper side 23a facing away from the plate underside 23b. Consequently, the positive-locked connection with the holding device 20 as described hereinabove can be established.

A single mating holding part 40 can be the component of several mating holding devices 21. In other words, respectively one mating holding projection 33 of the respective mating holding device 21 may project from the plate-shaped mating holding part 40 at the appropriately spaced apart points. Consequently, all mating holding devices 21 are connected to each other via the mating holding part 40 as a unit that can be handled in a uniform manner.

The support plate 23 can consist of electrically non-conductive material, or be coated or clad therewith. The separate fastening parts 38 may be electrically conductive and may optionally at least be partially electrically connected to one another, for example, via rigid or flexible electrical conductors or lines. As a result of this, conductor strips in the support plate 23 may be omitted.

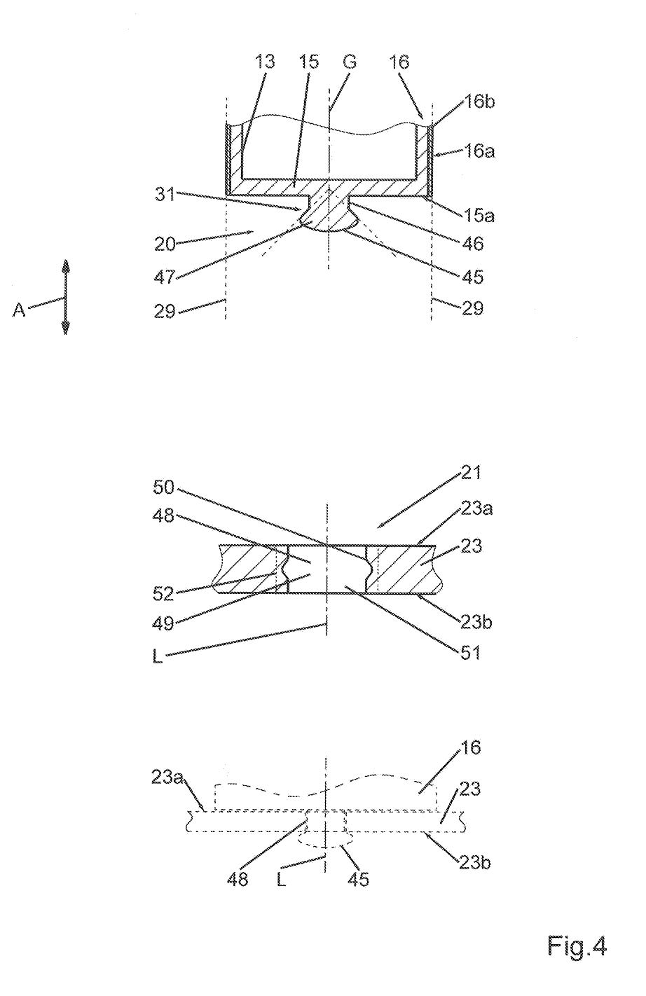

In the exemplary embodiment illustrated by FIG. 4 the holding device 20 is represented by a holding projection 45 extending along housing axis G. Adjoining the underside 15a of the bottom 15, the holding projection 45 has a neck portion 46 that is cylindrical in the exemplary embodiment. Adjoining the neck portion 46, the holding projection 45 widens and forms a head portion 47 that is greater in dimension radially with respect to housing axis G than the neck portion 46. As a result of this, an undercut 31 is formed in the transition region between the point of the head portion 47 having the maximum radial dimension and the neck portion 46.

The holding projection 46 is arranged inside the region delimited by the shell surface plane 29. The maximum diameter of the head portion 45 is preferably clearly smaller than the outside diameter of the peripheral wall 16.

The mating holding device 21 comprises a mating holding recess 48 in the support plate 23, said mating holding recess being complementary to the holding projection 45 and, in particular, the head portion 47. The mating holding recess 48 has an inner region 49 that is disposed to receive the head portion 47 of the holding projection 45. Adjoining the inner region 49, there is provided a constriction 50 at which the radial dimension of the mating holding recess 28 is reduced and, in particular, displays its smallest dimension that is adapted to the outside diameter of the neck portion 46. The depth of the mating holding recess 48 in axial direction A preferably corresponds to the length of the holding projection 45 in axial direction A, so that, with the positive-locked connection between the holding device 20 and the mating holding device 21, the underside 15a of the bottom 15 abuts against the plate upper side 23a of the support plate 23.

The mating holding recess 48 may be accessible from the plate underside 23b and, for this purpose, have a passage hole 51 that opens the mating holding recess 48 toward the plate underside 23b. In accordance with the example, the passage hole connects the plate underside 23b of the support plate 23 to the inner region 49 of the mating holding recess 48. Due to the passage hole 51, there exists the possibility of welding the holding projection 45 in the mating holding recess 48 from the side into which the plate underside 23b points.

The mating holding recess 48—as schematically shown by FIG. 4—may be arranged in an insert, for example in a sleeve 52, in the support plate 23. In doing so, it is possible to configure the insert or sleeve 52 in an electrically conductive manner and arrange it in an electrically insulating support plate 23.

As an alternative to the form described hereinabove, the mating holding recess 48 may also be cylindrical as is shown in dashed lines in FIG. 4 at the bottom. The holding projection 45 then projects on the plate underside 23b of the support plate 23—at least partially—and is able to reach around the support plate 23, as it were.

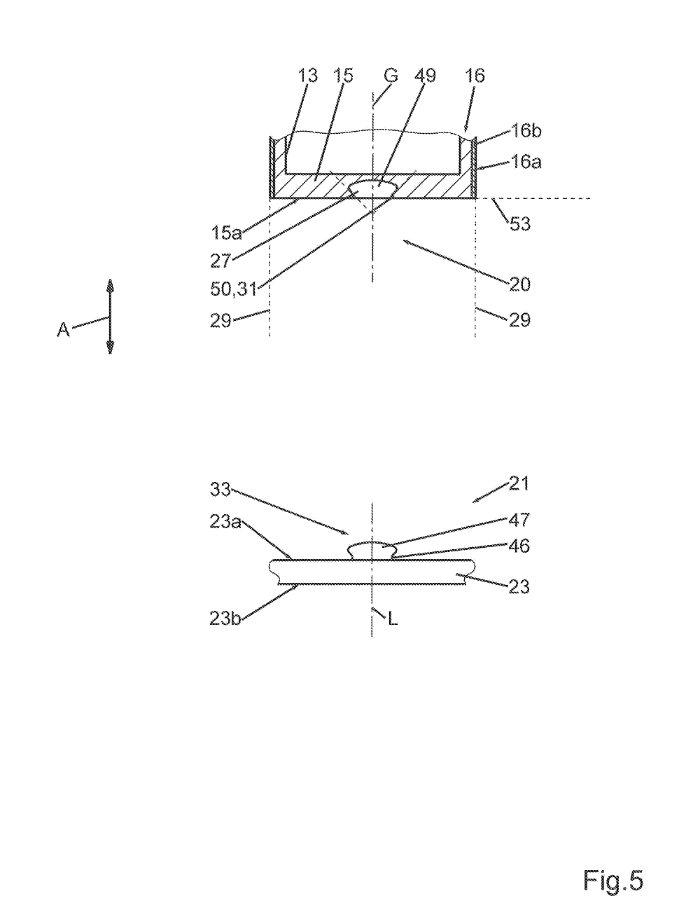

The further exemplary embodiment of the holding device 20 and the mating holding device 21 shown by FIG. 5 corresponds essentially to the reversal of the exemplary embodiment according to FIG. 4. Accordingly, the holding device 20 is formed by a holding recess 27 whose form basically corresponds to the mating holding recess 48 of FIG. 4. In the exemplary embodiment according to FIG. 5, the holding recess 27 is completely integrated in the bottom 15. Thus, the holding recess 27—analogously to the mating holding recess 48 of FIG. 4—has an inner region 49 that is adjoined by a constriction 50 with dimensions that decrease radially toward the housing axis. In the exemplary embodiment, this constriction 50 forms the undercut 31 of the holding device 20. The passage hole 51 does not exist in this embodiment. The holding recess 27 is completely separated from the interior space 13 by the bottom 15.

Accordingly, the mating holding device 21 has a mating holding projection 33 that corresponds to the holding projection 45 of FIG. 4, said mating holding projection extending along longitudinal axis L of the mating holding device 21 and away from the plate upper side 23a of the support plate 23. This mating holding projection 33 has—corresponding to the holding projection 45 of FIG. 4—a neck portion 46 adjoining the plate surface 23a and a head portion 47 adjoining the neck portion 46, said head portion having larger dimensions radially with respect to longitudinal axis L. The positive-locked connection between the holding device 20 and the mating holding device 21 takes place analogous to the exemplary embodiment of FIG. 4, in which case—here—also the underside 15a of the bottom 15 and the plate upper side 23a are in contact with each other when the positive-locking connection is established.

The optional features can be provided in all exemplary embodiments in view of the electrical contacting of the holding device 20 and the mating holding device 21 with the interior space 13 or the core material 14 and/or the at least partial electrical insulation of the battery cell housing 10, as have been explained in conjunction with the exemplary embodiments hereinabove and, in particular, in conjunction with FIG. 2.

In the exemplary embodiments of the housing shell 12, in which the holding device 20 is a holding recess 27, the point where the holding recess 27 displays its maximum radial dimension is located at a distance from a contact plane 53. In the exemplary embodiment shown by FIG. 5 the contact plane 53 is the plane in which extends the underside 15a of the bottom 15. Generally, the contact plane 53 is the plane that is oriented at a right angle with respect to housing axis G and that is applied to the housing shell 12 in such a manner that it comprises several contact locations (points or areas) with the bottom 15 or the holding device 20, without intersecting the bottom 15 or the holding device 20. With the positive-locked connection established, the plate upper side 23a preferably extends inside the contact plane 53 and supports the housing shell 12 against tilting.

From FIGS. 2 and 3 it can be inferred that, there, the contact plane 53 is formed on the lower edge of the strip 28 facing in axial direction A, said strip abutting against the plate upper side 23a with the positive-locking connection established.

FIGS. 6-8 schematically illustrate an exemplary embodiment of a support 22 as can be used for the battery cell housings 10 or the holding devices 20 that have been explained hereinabove. The support plate 23 extends at a right angle with respect to axial direction A in a first direction x and at a right angle to the first direction in a second direction y. The support plane 23 may be delimited on several or on all side—in accordance with the example, on three sides—by means of a support lateral wall 57. The support lateral walls 57 extend away from the plate upper side 23a in axial direction A. The thusly delimited region may be open on one side and consequently be free of a support lateral wall 57. The battery cylinders 10 can be inserted or slipped in from this side.

Several mating holding devices 21 are arranged in a specified pattern on the support plate 23. The midpoints of the mating holding devices 21 that are located at the point where the longitudinal axis L intersects the plane in which the plate upper side 23a extends from the corner points 58 of a grid that comprises polygonal grid meshes 59. A few corner points 58 and grid meshes 59 are shown as examples by FIG. 6. Preferably the grid meshes 59 are triangular and each represents a equilateral triangle. Alternatively, the corner points 58 may also form square grid meshes 59.

It is preferred that the distance between the corner points be selected in such a manner that the edge length of one grid mesh corresponds to the diameter of the peripheral wall 16 in a housing shell 12 or a battery cell housing 10. As a result of this, adjacent battery cell housings 10 or housing shells 12 are in contact with each other. This contact is advantageous for providing a contact for heat conduction when grouping a plurality of battery cell housings 10, as a result of which the heat transport can be improved. Furthermore, it is advantageous if the battery cell housings 10 arranged on the edge are in contact with the respectively adjacent support lateral wall 57, as a result of which the heat dissipation by heat conduction can also be improved.

As has already been explained, one or more conductor strips 37 may be arranged on the support plate 22 for electrically contacting or connecting a plurality of battery cells in order to electrically connect mating holding devices 21 to one another, these being electrically conductive in this case. The type of connection and the resultant pattern depend on the desired electrical circuit. The individual battery cells may be electrically connected in series and/or in parallel. This depends on the battery voltage and the electrical power that are ultimately to be provided by the battery comprising the plurality of battery cells.

FIG. 7 shows schematically—in dashed lines—electrical connections 60 that are not a component of the support plate 23 but that can be established by separate lines or connecting elements on the respectively other terminal of the battery cells, said terminal being provided, for example, on the side of the battery cell facing away from the support plate. These electrical connections 60 may be implemented, for example, in a not shown cover plate in the form of conductor strips that can be arranged on the battery cell housings 10. Such a cover plate can be connected, for example to the support lateral walls 57 and can thus be a component of the support 22. The electrical connections 60 may also be implemented by using other known electrical connecting means.

In a preferred embodiment, the battery cells may be arranged on a common support 22 in such a manner that either all the plus poles or all the minus poles are arranged on the side associated with the support plate 23. It is understood that it is also possible to arrange the battery cells in another orientation, so that, for example, a part of the battery cells has the plus pole on the side associated with the support plate 23, while another part of the battery cells has the minus pole on the side associated with the support plate 23.

The grouping of several battery cells with respectively one battery cell housing 10 on one support 20 shall be explained hereinafter with reference to FIG. 8.

Considering the exemplary embodiment described herein, the individual battery cells are produced initially, so that the battery cell housing 10 can be closed and the housing cover 11 is connected to the housing shell 12 in a material-bonded manner. The battery cell housings 10 that are to be arranged on a support 22 are grouped and grasped, for example by a handling device 65, e.g., a gripping device or the like. The handling device 65 can clamp the battery cell housings 10 against each other and move them in this manner. With the aid of the handling device 65, the battery cell housings 10 are moved over the plate upper side 23a of the support plate 23 until the housing axis G of each battery cell housing 10 coincides with the longitudinal axis L of the respectively associate mating holding device 21. Subsequently, the battery cell housings are moved together at a right angle with respect to the support plate 23 in axial direction A, as a result of which a positive-locking connection is achieved between the holding device 20 provided on one battery cell housing 10, respectively, and the associate mating holding device 21 on the support 22. The handling device 65 may subsequently be removed. The battery cell housings 10 are held on the support 22 and grouped there.

When the battery cell housings 10 are moved onto the support plate 23 the support lateral walls 57 may act as a guiding aid. In doing so, it is also possible for the handling device 65 not to exert a clamping force on the battery cell housings 10 but only reach around them in order to prevent tilting. The group of the battery cell housings 10 may then be pushed as a unit on and over the plate upper side 23a until each battery cell housing 10 has reached the desired position. Considering the peripheral walls 16 that have the configuration of a circular cylinder and the arrangement of the mating holding devices 21 on the corner points of a grid structure having triangular grid meshes 59 (equilateral triangles), the battery cell housings 10 position themselves very simply relative with respect to each other in the respectively desired orientation.

After establishing the positive-locking connection between the holding devices 20 and the mating holding devices 21, the resultant assembly comprising the support 22 and the battery cells or battery cell housings 10 can be handled very easily during the continued manufacturing process of the battery. For example, all battery cells arranged on a support 22 can be connected in a material-bonded manner to the support 22 or fixed in another manner against vibrations and other outside effects on the support 22. The battery cells 10 may also be electrically charged together (forming).

Alternatively, it is also possible to mount only the housing shells 12 to the support 22 in the manner described hereinabove and to subsequently introduce the core materials 14 in the housing shells 12 and to close the housing shells 12 with a respectively associate housing cover 11.

The battery with a plurality of battery cells that is to be produced may comprise several battery cell groups that are arranged on respectively one support.

The invention relates to a battery cell housing 10 with a housing shell 12 and a housing cover 11. A holding device 20 is arranged on a bottom 15 of the housing shell 12. The holding device 20 is assigned a mating holding device 21 on a support 22. The holding device 20 and the mating holding device 21 are configured to be plugged positively one inside the other by a relative movement in an axial direction parallel to the housing axis G of the cylindrical battery cell housing 10. In this way, it is possible at the same time for a plurality of battery cell housings 10 bearing against one another to be arranged quickly and captively on a support 22 with a plurality of mating holding devices 21.

### LIST OF REFERENCE SIGNS

10 Battery cell housing
11 Housing cover
12 Housing shell
13 Interior space
14 Core material
15 Bottom
15a Underside of bottom
16 Peripheral wall
16a Peripheral shell surface of the peripheral wall
16b Electrically insulating layer
17 Housing opening
20 Holding device
21 Mating holding device
22 Support
23 Support plate
23a Plate upper side of the support plate
23b Plate underside of the support plate
27 Holding recess
28 Strip
29 Shell surface plane
30 Radial projection
31 Undercut
33 Mating holding projection
34 End section
35 Peripheral recess
36 Peripheral projection
37 Conductor strip
38 Fastening part
39 Connecting section
40 Mating holding part
41 Cutout
45 Holding projection
46 Neck portion
47 Head portion
48 Mating holding recess
49 Inner region
50 Constriction
51 Passage hole
52 Sleeve
53 Contact plane
57 Support lateral wall
58 Corner point
59 Grid mesh
60 Electrical connection
65 Handling device
α Angle
A Axial direction
G Housing axis
L Longitudinal axis
x First direction
y Second direction

1. Battery cell housing (10) for the accommodation of a core material (14) providing electrical energy, the battery cell housing comprising:
a hollow cylindrical housing shell (12) that comprises a peripheral wall (16) extending around a bottom (15) and a housing axis (G), said peripheral wall extending away from the bottom (15) in an axial direction (A) parallel to the housing axis (G) and delimiting, on an axial side opposite the bottom (15), a housing opening (17),
a housing cover (11) that is adapted to cover the housing opening (17) and to be connected to the peripheral wall (16),
a holding device (20) present on the bottom (15), said holding device adapted to be fastened in a positive-locking manner to a mating holding device (21) on a support (22) and to secure the housing shell (12) against an unwanted axial movement on the support (22).

2. Battery cell housing according to claim 1, wherein the holding device (20) is arranged, radially with respect to the axial direction (A), inside a region that is delimited by a tube-shaped shell surface plane (29), in which the peripheral wall (16) extends.

3. Battery cell housing according to claim 1, wherein the holding device (20) has an undercut (31).

4. Battery cell housing according to claim 1, wherein the holding device (20) is connected in an electrically conductive manner to a core material (14) arranged in an interior space (13) of the housing shell (12).

5. Battery cell housing according to claim 1, wherein an outside surface (16a) of the peripheral wall (16) is electrically insulated with respect to an interior space (13) of the housing shell (12).

6. Battery cell housing according to claim 1, wherein the holding device (20) has a holding projection (45) extending away from an underside (15a) of the bottom (15).

7. Battery cell housing according to claim 6, wherein a dimension of the holding projection (45) radially with respect to the axial direction (A) is at a maximum at a location being at a distance from the bottom (15).

8. Battery cell housing according to claim 1, wherein the holding device (20) has a holding recess (27).

9. Battery cell housing according to claim 8, wherein a dimension of the holding recess (27) radially with respect to the axial direction (A) is at a minimum at a location that is at a distance from an underside (15a) of the bottom (15).

10. Support (22) for a plurality of cylindrical battery cell housings (10) or their housing shells (12), the support comprising:
with a support plate (23) on which several mating holding devices (21) are arranged adapted to being fastened in a positive-locking manner to respectively one holding device (20) provided on the housing shell (12) and to secure the housing shell (12) on the support plate (23) against an unwanted axial movement in an axial direction (A) parallel to the housing axis (G) of the housing shells (12),
wherein each of the mating holding devices (21) is adapted to being connected in a positive-locking manner to the holding device (20) provided on the housing shell (12) due to a movement in the axial direction (A) relative to the associate housing shell (12).

11. Support according to claim 10, wherein the support plate (23) has one support lateral wall (57), respectively, on one or more sides.

12. Support according to claim 10, wherein the mating holding devices (21) are an integral part of the support plate (23).

13. Support according to claim 10, wherein the mating holding devices (21) are provided on one or more separate fastening parts (38), wherein each of the mating holding devices (21) and/or the holding devices (20)—with the positive-locking connection established—extends at least partially through an associated through hole (41) in the support plate (23) and, as a result of this, fastens the housing shell (12) to the support plate (23).

14. Support according to one of the claim 10, wherein the mating holding devices (21) are arranged at a distance from one another in such a manner that the peripheral walls (16) of the housing shells (12) mounted thereto are in contact with adjacent one of the housing shells (12).

15. Support according to one of the claim 10, wherein the mating holding devices (21) are made at least partially of electrically conductive material.

16. Support according to claim 15, wherein at least a part of the provided mating holding devices (21) is connected to respectively at least one conductor strip (37) or at least one electrical conductor, wherein the at least one conductor strip (37) or the at least one electrical conductor is arranged on the support plate (23).

17. Method for grouping a plurality of battery cell housings (10) or their housing shells (12), the method comprising:
Providing a plurality of battery cell housings (10) with one housing shell (12) respectively, or providing a plurality of housing shells (12), each having a hollow cylindrical form and having a peripheral wall (16) extending around a bottom (15) and a housing axis (G) respectively, said peripheral wall extending away from the bottom (15) in an axial direction (A) and having a holding device (20) on the bottom (15),
Providing a support (22) with a support plate (23) on which several mating holding devices (21) are arranged,
Producing a positive-locking connection between the holding devices (20) of the housing shells (12) and the mating holding devices (21) of the support (22) due to a relative movement in axial direction (A) parallel to the housing axes (G).

18. Method according to claim 17, wherein fully assembled battery cells with the battery cell housing (10) closed are arranged on the support (22).

19. Method according to claim 18, wherein the battery cells already received a forming when they are arranged on the support (22).

20. Method according to claim 17, wherein the battery cells are produced ready for use and/or receive a forming individually or in groups after they have been arranged on the support (22).
